(19) United States
(12) Patent Application Publication
(10) Pub. No.: US 2009/0177462 A1
(43) Pub. Date: Jul. 9, 2009

(54) WIRELESS TERMINALS, LANGUAGE TRANSLATION SERVERS, AND METHODS FOR TRANSLATING SPEECH BETWEEN LANGUAGES

(75) Inventor: Johan Alfven, Malmo (SE)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 11/968,672

(22) Filed: Jan. 3, 2008

(51) Int. Cl. G06F 17/28

(52) U.S. Cl. 704/3

(57) ABSTRACT

Wireless terminals, language translation servers, and methods for translating speech between languages are disclosed. A wireless communication terminal can include a speaker, a wireless transceiver, and a controller circuit. The controller circuit is configured to operate differently in a language translation mode than when operating in a non-language translation mode. When operating in the language translation mode, the controller circuit transmits a speech signal containing speech in a first spoken language via the transceiver to a language translation server, it receives from the language translation server a translated speech signal in a second spoken language which is different from the first spoken language, and it plays the translated speech signal through the speaker.

### BACKGROUND OF THE INVENTION

The present invention relates to wireless communication terminals and, more particularly, to providing user functionality that is distributed across a wireless communication terminal and network infrastructure.

Software that enables translation between different written languages is now available for use on many types of computer devices, such as on laptop/desktop computers and personal digital assistants (PDAs). While translation of written languages may readily be carried out on such computer devices, accurate translation of spoken languages can require processing resources that are beyond the capabilities of at least mobile computer devices. Moreover, the processing and memory requirements of computer devices would increase dramatically with an increase in the number of languages between which spoken language can be translated.

### SUMMARY

Some embodiments of the present invention are directed to wireless communication terminals that include a speaker, a wireless transceiver, and a controller circuit. The controller circuit is configured to operate differently in a language translation mode than when operating in a non-language translation mode. When operating in the language translation mode, the controller circuit transmits a speech signal containing speech in a first spoken language via the transceiver to a language translation server, it receives from the language translation server a translated speech signal in a second spoken language which is different from the first spoken language, and it plays the translated speech signal through the speaker.

In some further embodiments, when operating in the language translation mode, the controller circuit records the speech signal into a voice file, transmits the voice file to the language translation server, receives a translated language speech file containing the translated speech signal in the second spoken language, and plays the translated speech signal through the speaker.

In some further embodiments, when operating in the language translation mode, the controller circuit generates metadata that indicates presence of the first spoken language and/or the second spoken language out of a plurality of possible spoken languages, and transmits the metadata to the language translation server for use in translating speech in the speech signal from the first spoken language to the second spoken language.

In some further embodiments, the controller circuit identifies a language of the speech in response to what language setting has been selected by a user for display of one or more textual menus on the wireless terminal, and generates the metadata in response to the identified language. The metadata generated by the controller circuit may identify a present geographic location of the wireless terminal. The controller circuit may query a user to identify at least one of the first and second languages, and the metadata generated by the controller circuit may identify the user response to the query.

In some further embodiments, when operating in the language translation mode, the controller circuit selects a sampling rate, a coding rate, and/or a speech coding algorithm that is different than that selected when operating in the non-language translation mode and which is used to regulate conversion of speech in the first spoken language into the speech signal that is transmitted to the language translation server.

In some further embodiments, when operating in the language translation mode, the controller circuit selects a higher sampling rate, a higher coding rate, and/or a speech coding algorithm providing better quality speech coding in the speech signal than that selected when operating in the non-language translation mode.

In some further embodiments, when operating in the language translation mode the controller circuit receives a command from the language translation server that identifies a sampling rate, a coding rate, and/or a speech coding algorithm that is preferred for use when generating the speech signal for transmission to the language translation server, and the controller circuit responds to the command by selecting the sampling rate, the coding rate, and/or the speech coding algorithm that it uses to generate the speech signal for transmission to the language translation server.

In some further embodiments, when operating in the language translation mode the controller circuit generates metadata that is indicative of the selected sampling rate, coding rate, and/or speech coding algorithm, and transmits the metadata to the language translation server for use in translating speech in the speech signal from the first spoken language to the second spoken language.

In some further embodiments, when operating in the language translation mode the controller circuit receives a speech recognition playback signal from the language translation server that contains speech generated by the language translation server as corresponding to what it recognized in the speech signal, it plays the speech recognition playback signal through the speaker, it queries a user regarding acceptability of accuracy of speech in the speech recognition playback signal, and it transmits the user response to the query to the language translation server.

Some other embodiments are directed to a language translation server that includes a network interface, a speech recognition unit, and a language translation unit. The network interface is configured to communicate with wireless terminals via a wireless communication system. The speech recognition unit is configured to receive a speech signal in a first spoken language from the wireless terminals, and to map the received speech signal to predefined data. The language translation unit is configured to generate translated speech in a second spoken language, which is different from the first spoken language, in response to the predefined data, and to transmit the translated speech to the wireless terminals.

In some further embodiments, the language translation unit receives metadata that indicates a geographic location of one of the wireless terminals, and selects the second spoken language among a plurality of spoken languages and into which it generates the translated speech for the wireless terminal in response to the indicated geographic location.

In some further embodiments, the language translation unit receives metadata that identifies geographical coordinates of the wireless terminal and/or indicates a geographic location of network infrastructure that is communicating with and is proximately located to the wireless terminal, and selects the second spoken language among a plurality of spoken languages and into which it generates the translated speech for the wireless terminal in response to the metadata.

In some further embodiments, the speech recognition unit receives metadata from one of the wireless terminals that identifies a language setting that has been selected by a user for display of one or more textual menus on the wireless terminal, and uses the metadata to identify the first spoken language among a plurality of spoken languages and to recognize speech in a speech signal received from the wireless terminal.

In some further embodiments, the speech recognition unit receives metadata that identifies a home geographic location of one of the wireless terminals, and uses the identified home geographic location to identify the first spoken language among a plurality of spoken languages and to recognize speech in a speech signal received from the wireless terminal.

In some further embodiments, the speech recognition unit transmits a command to one of the wireless terminals that identifies a sampling rate, a coding rate, and/or a speech coding algorithm that is preferred for use when generating the speech signal for transmission to the language translation server.

In some further embodiments, the speech recognition unit receives metadata from one of the wireless terminals that identifies a sampling rate, a coding rate, and/or a speech coding algorithm that will be used by the wireless terminal when generating the speech signal for transmission to the language translation server.

In some further embodiments, the speech recognition unit generates a speech recognition playback signal that contains speech generated by the speech recognition unit as corresponding to what it recognized in the speech signal from one of the wireless terminals, transmits the speech recognition playback signal to the wireless terminal, and receives a user response from the wireless terminal regarding acceptability of accuracy of speech in the speech recognition playback signal. The language translation unit selectively transmits translated speech in the second language to the wireless terminal in response to the user response.

Some other embodiments are directed to a method of electronically translating speech between different languages. The method includes: carrying out by a wireless terminal, recording a speech signal of a first spoken language into a voice file and transmitting the voice file to a language translation server; carrying out by the language translation server, receiving the voice file, generating a file of translated speech in a second spoken language, which is different from the first spoken language, in response to speech in the voice file and transmitting the file of translated speech in the second spoken language to the wireless terminal; and carrying out by the wireless terminal, receiving the file of translated speech and playing the speech in the second spoken language through a speaker.

Other electronic devices and/or methods according to embodiments of the invention will be or become apparent to one with skill in the art upon review of the following drawings and detailed description. It is intended that all such additional electronic devices and methods be included within this description, be within the scope of the present invention, and be protected by the accompanying claims.

### BRIEF DESCRIPTION OF THE DRAWINGS

The accompanying drawings, which are included to provide a further understanding of the invention and are incorporated in and constitute a part of this application, illustrate certain embodiments of the invention. In the drawings:

FIG. 1 is a schematic block diagram of a communication system that includes an exemplary wireless terminal and an exemplary language translation server which are configured to operate in accordance with some embodiments of the present invention;

FIG. 2 is a schematic block diagram illustrating further aspects of the exemplary wireless terminal and language translation server shown in FIG. 1 in accordance with some embodiments of the present invention;

FIG. 3 is a flowchart and data flow diagram showing exemplary operations of a wireless terminal and a language translation server in accordance with some embodiments of the invention; and

FIG. 4 is a flowchart and data flow diagram showing exemplary operations of a wireless terminal and a language translation server in accordance with some embodiments of the invention.

### DETAILED DESCRIPTION

The present invention will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to another element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure. Although some of the diagrams include arrows on communication paths to show a primary direction of communication, it is to be understood that communication may occur in the opposite direction to the depicted arrows.

Some embodiments are described with regard to block diagrams and operational flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

For purposes of illustration and explanation only, various embodiments of the present invention are described herein in the context of mobile terminals that are configured to carry out cellular communications (e.g., cellular voice and/or data communications) and/or short range communications (e.g., wireless local area network and/or Bluetooth). It will be understood, however, that the present invention is not limited to such embodiments and may be embodied generally in any wireless communication terminal that is configured to communicate with a language translation server.

Various embodiments of the present invention provide a system that enables people to use their wireless terminals to have their speech electronically translated from their original spoken language into a different target spoken language that can be broadcast through a speaker for listening by another person. Thus, for example, a person can speak Swedish into a wireless terminal and have such speech electronically translated into another language, such as German, and played-back through the wireless terminal for listening by another person. Such electronic language translation capability can be provided by a system that includes wireless terminals that communicate with a language translation server through various wireless and wireline communication infrastructure.

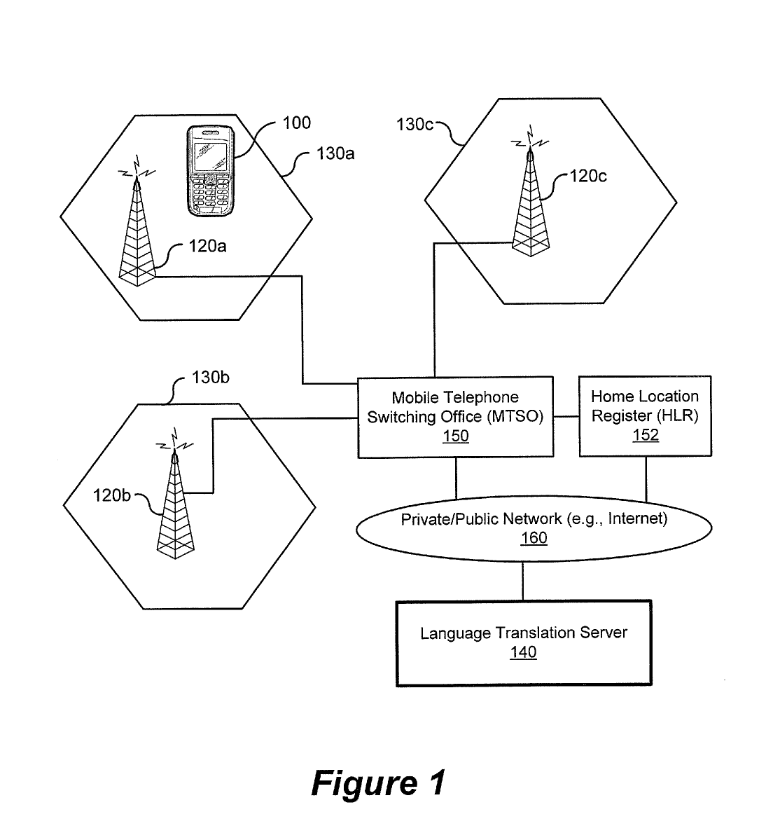

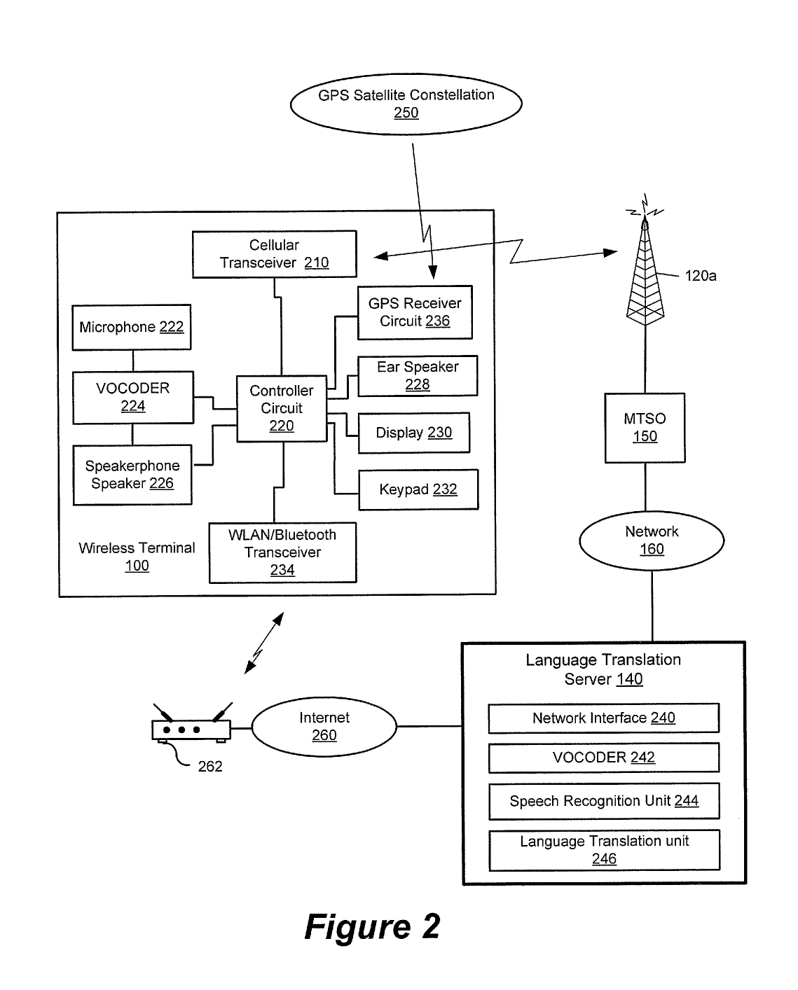

FIG. 1 is a schematic block diagram of a communication system that includes an exemplary wireless terminal 100 and an exemplary language translation server 140 which are configured to operate in accordance with some embodiments of the present invention. FIG. 2 is a schematic block diagram illustrating further aspects of the exemplary wireless terminal 100 and the language translation server 140 shown in FIG. 1 in accordance with some embodiments of the present invention.

Referring to FIGS. 1 and 2, the wireless terminal 100 can include a cellular transceiver 210 that can communicate with a plurality of cellular base stations 120a-c, each of which provides cellular communications within their respective cells 130a-c. The cellular transceiver 210 can be configured to encode/decode and control communications according to one or more cellular protocols, which may include, but are not limited to, Global Standard for Mobile (GSM) communication, General Packet Radio Service (GPRS), enhanced data rates for GSM evolution (EDGE), code division multiple access (CDMA), wideband-CDMA, CDMA2000, and/or Universal Mobile Telecommunications System (UMTS).

The wireless terminal 100 can communicate with the language translation server 140 through various wireless and wireline communication infrastructure, which can include a mobile telephone switching office (MTSO) 150 and a private/public network (e.g., Internet) 160. Registration information for a subscriber of the wireless terminal 100 can be contained in a home location register (HLR) 152.

The wireless terminal 100 can further include a controller circuit 220, a microphone 222, a voice encoder/decoder (vocoder) 224, a speakerphone speaker 226, an ear speaker 228, a display 230, a keypad 232, a wireless local area network (WLAN)/Bluetooth transceiver 234, and/or a GPS receiver circuit 236. As shown in FIG. 2, the wireless terminal 100 may alternatively or additionally communicate with the language translation server 140 via the WLAN (e.g., IEEE 802.11b-g)/Bluetooth transceiver 234 and a proximately located WLAN router/Bluetooth device 262 connected to a network 260, such as the Internet.

The controller circuit 220 is configured to operate differently in a language translation mode than when operating in at least one non-language translation mode. When operating in the language translation mode, a user can speak in a first language into the microphone 222 and with that speech encoded by the vocoder 224. The controller circuit 220 transmits a speech signal containing the encoded speech via the cellular transceiver 210 and/or via the WLAN/Bluetooth transceiver 234 to the language translation server 140.

The language translation server 140 can include a network interface 240, a vocoder 242, a speech recognition unit 244, and a language translation unit 246. The network interface 240 can communicate with the wireless terminal 100 via the wireless and wireline infrastructure. The vocoder 242 can decode voice in a speech signal that is received from the wireless terminal 100. The speech recognition unit 244 receives a speech signal in the first spoken language from the wireless terminal 100, and carries out speech recognition to map recognized speech to predefined data. The language translation unit 246 generates a translated speech signal in a second spoken language, which is different from the first spoken language, in response to the predefined data generated by the speech recognition unit 244. The language translation unit 246 transmits the translated speech through the network interface 240 and the wireless and wireline infrastructure to the wireless terminal 100. The translated speech signal that is transmitted to the wireless terminal 100 may be encoded by the vocoder 242 before transmission.

The translated speech signal is received by the wireless terminal 100, such as through the cellular transceiver 210 and/or the WLAN/Bluetooth transceiver 234, and played by the controller circuit 220 through the speakerphone speaker 226 and/or the ear speaker 228. When the translated speech signal has been encoded, the vocoder 224 may be used to decode the translated speech signal.

It is to be understood that although the exemplary embodiments of the wireless terminal 100, the language translation server 140, and the wireless and wireline infrastructure have been illustrated with various separately defined elements for ease of illustration and discussion, the invention is not limited thereto. Instead, various functionality described herein in separate functional elements may be combined within a single functional element and, vice versa, functionally described herein in single functional elements can be carried out by a plurality of separate functional elements.

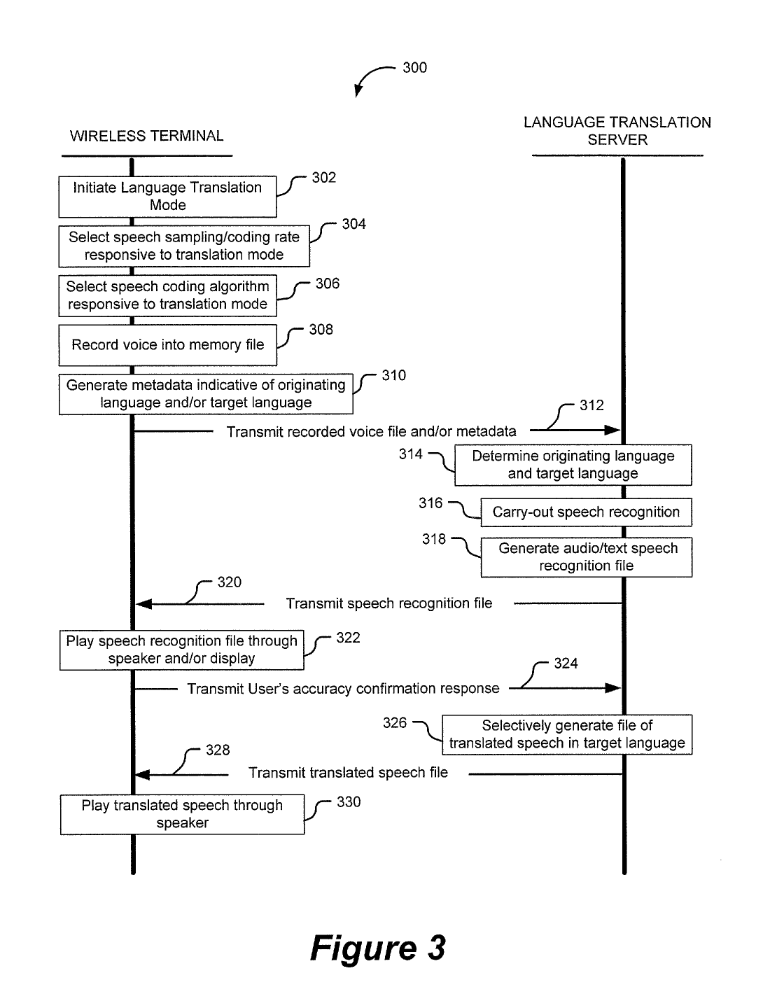

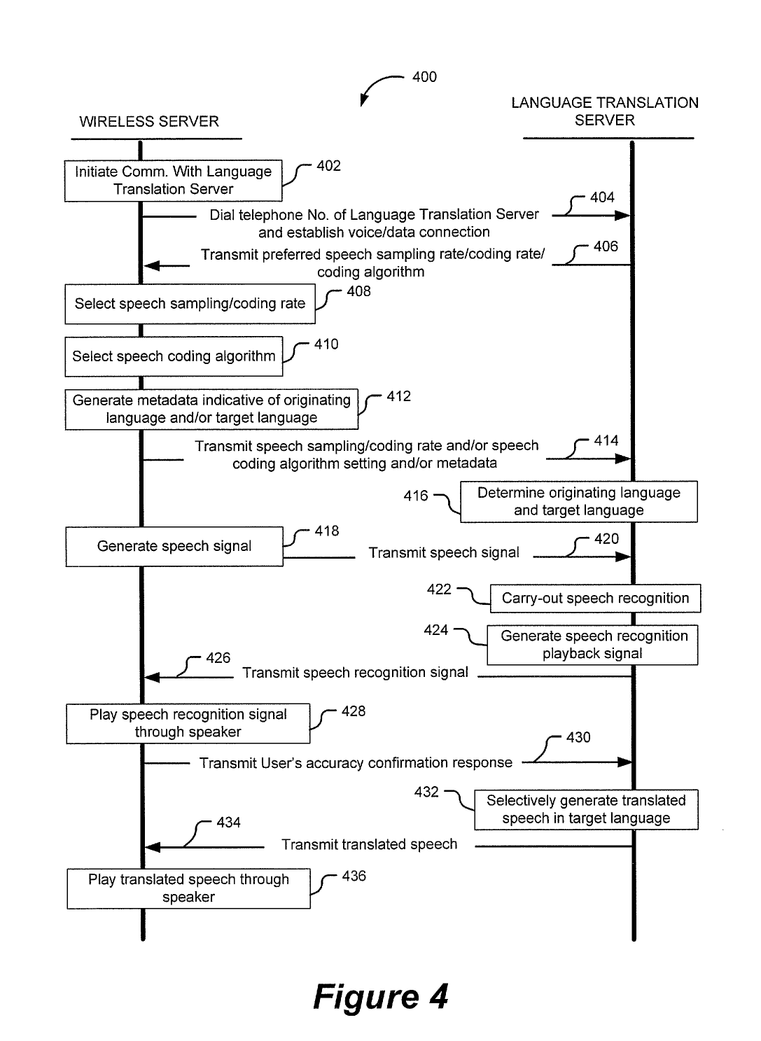

Various further embodiments of the present invention will now be described with further reference to FIGS. 3 and 4. FIG. 3 illustrates a flowchart and data flow diagram 300 of exemplary operations of a wireless terminal and a language translation server, such as the terminal 100 and the server 140 of FIGS. 1 and 2, in accordance with some embodiments of the invention. FIG. 4 illustrates a flowchart and data flow diagram 400 of exemplary operations of a wireless terminal and a language translation server, such as the terminal 100 and the server 140 of FIGS. 1 and 2, in accordance with some other embodiments of the invention.

Referring initially to FIG. 3, a user can trigger the wireless terminal 100 to operate in a language translation mode (block 302) by, for example actuating one or more buttons on the keypad 232 and/or via other elements of a user interface. In response to initiation of the language translation mode, the controller circuit 220 can select (block 304 and 306) a speech sampling rate, an encoding rate, and/or a coding algorithm that is, for example, used by the vocoder 224 to encode speech from the microphone 222 into a speech signal may be transmitted to the language translation server 140. The controller circuit 220 may select a sampling rate, a coding rate, and/or a speech coding algorithm that is different than what it selects for use when operating in the non-language translation mode, and which is used to regulate conversion of speech into a speech signal by, for example, the vocoder 224. The speech signal can be recorded (block 308) into a voice file in memory of the controller circuit 220 and/or within a separate memory within the wireless terminal 100.

Accordingly, when operating in the language translation mode, the controller circuit 220 can select a higher sampling rate, higher coding rate, and/or a speech coding algorithm that provides better quality speech coding in the speech signal than what is selected in use when operating in a non-language translation mode. Consequently, the speech signal can contain higher fidelity reproduction of the speech sensed by the microphone 222 when the wireless terminal 100 is operating in the language translation mode so that language translation server 140 may more accurately carry-out recognition (e.g., within the speech recognition unit 244) and/or translation (e.g., within the language translation unit 246) of received speech into the target language for transmission back to the wireless terminal 100.

The controller circuit 220 may, for example, control the vocoder 224 to select among speech coding out algorithms that can include, but are not limited to, one or more different bit rate adaptive multi-rate (AMR) algorithms, full rate (FR) algorithms, enhanced full rate (EFR) algorithms, half rate (HR) algorithms, code excited linear prediction (CELP) algorithms, selectable mode vocoder (SMV) algorithms. In one particular example, the controller circuit 220 may select a higher code rate, such as 12.2 kbit/sec, for an AMR algorithm when operating in the language translation mode, and select a lower code rate, such as 6.7 kbit/sec, for the AMR algorithm when operating in the non-language translation mode.

The controller circuit 220, when operating in the language translation mode, can generate metadata (block 310) that is indicative of the selected sampling rate, the coding rate, and/or the speech coding algorithm. The controller circuit 220 can transmit the metadata and the recorded voice file (dataflow 312) to the language translation server 140. The language translation server 140 can use the metadata to select and/or adapt speech recognition parameters/algorithms (e.g., within the speech recognition unit 244) and/or language translation parameters/algorithms (e.g., within the language translation unit 246) so as to more accurately carry-out recognition and/or translation of speech in the speech signal into the target language for transmission back to the wireless terminal 100.

The controller circuit 220, when operating in the language translation mode, can alternatively or additionally generate the metadata so that it indicates which of a plurality of spoken languages are contained in the speech of the recorded voice file and/or that indicates which of a plurality of spoken languages are to be used as a target language for the translation of the speech in the recorded voice file. The language translation server 140 (e.g. the speech recognition unit 244 therein) can use the metadata to determine (block 314) which one of a plurality of possible spoken languages is contained in the speech of the recorded voice file and/or to identify what target language among a plurality of spoken languages a user desires for the speech to be translated into. Accordingly, use of the metadata may improve the accuracy of the speech recognition and/or language translation by the language translation server 140. Accordingly, the speech recognition unit 244 can select among a plurality of spoken languages for the original and target languages in response to the metadata.

The controller circuit 220 can determine which of a plurality of spoken languages is used in the speech signal in response to what language setting has been selected by a user for display of one or more textual menus for the display 230. Thus, for example, when a user has defined French as a language in which textual menus are to be displayed on the display 230, the controller circuit 220 can determine that any speech that is received through the microphone 222, while that setting is established, is being spoken in French, and can generate metadata that indicates that determination. Accordingly, the speech recognition unit 244 can select one of a plurality of spoken languages as the original language in response to the user's display language setting.

The controller circuit 220 can generate metadata so as to indicate a present geographic location of the wireless terminal. The controller circuit 220 can determine its geographic location, such as geographic coordinates, through the GPS receiver circuit 236 which uses GPS signals from a plurality of satellites in a GPS satellite constellation 250 and/or assistance from the cellular system (e.g., cellular system assisted positioning). The language translation server 140 (e.g. the speech recognition unit 244 therein) can use the geographic location of the wireless terminal 100 indicated by the metadata and knowledge of a primary language that is spoken in the associate geographic region, and can select that primary language as the target language for translation.

The language translation server 140 may alternatively or additionally receive metadata from the wireless and/or wireline infrastructure that indicates a geographic location of cellular network infrastructure that is communicating with them is approximately located to the wireless terminal, such as metadata that identifies a base station identifier and/or routing information that is associated with known geographic location/regions and which are therefore indicative of a primary language that is spoken at the present geographic region of the wireless terminal 100. The language translation server 140 may therefore determine using the metadata that a user is presently located in a certain city in Germany, and can therefore select German, among a plurality of spoken languages, as the target language for translation.

The language translation server 140 may alternatively or additionally receive metadata that identifies a home geographic location of a wireless terminal 100, such as by querying the HLR 152, and can use the identified location to identify the original language spoken by the user. Therefore, the language translation server 140 can select Swedish, among a plurality of known spoken languages, as the original language spoken by the user when the user is registered with a cellular operator in Sweden.

Alternatively or additionally, the controller circuit 220 can query the user to identify at least one of the originating and/or target languages and can generate the metadata in response to the user's response.

The speech recognition unit 244 carries out recognition of speech (block 316) in the speech signal in the recorded voice file, and maps the recognized speech to predefined data which may be indicative of words identified in the selected original spoken language. The speech recognition unit 244 may generate an audio/text speech recognition file (block 318), which it transmits (dataflow 320) through the network interface 240 and the wireline and wireless infrastructure to the wireless terminal 100. The controller circuit 220 of the wireless terminal 100 may play (block 322) the speech recognition file through the speaker(s) 226/228 and/or display text from the speech recognition file on the display 230 to enable the user thereof to verify and confirm accuracy of the speech recognized by the speech recognition unit 244. The controller circuit 220 can query the user regarding acceptability of accuracy of the recognized speech, and can transmit (dataflow 324) the user's response to the language translation server 140.

The language translation unit 246 generates translated speech (block 326) into the selected target spoken language, which is different from the original spoken language, in response to the predefined data generated by the speech recognition unit 244. The language translation unit 246 transmits (dataflow 328) the translated speech, such as within a translated speech file, through the network interface 240 and the wireline and wireless infrastructure to the wireless terminal 100. The translated speech file may be encoded, such as by the vocoder 242, before transmission. The language translation unit 246 may selectively generate/not generate the translated speech or may selectively transmit/not transmit the translated speech in response to whether the user indicated that the accuracy of the recognize speech is acceptable.

The controller circuit 220 of the wireless terminal 100 plays (block 330) the translated speech within the translated speech file through the speaker(s) 226/228. When the translated speech file is encoded by the vocoder 242 of the language translation server 140, it can be decoded by the vocoder 224 before being audibly broadcast from the wireless terminal 100. Accordingly, a user can speak a first language into the wireless terminal 100, and have the spoken words electronically translated by the language translation server 140 into a different target language which is then broadcast from the wireless terminal 100 for listening by another person.

Reference is now made to the flowchart and data flow diagram 400 of FIG. 4, which contains many similar operations and data flows to those shown in FIG. 3. In contrast to FIG. 3, in FIG. 4 a user's speech and the translated speech can be communicated between the wireless terminal 100 and the language translation server 140 through a voice communication link established there between, instead of being recorded and transferred within file.

In response to a user initiating the language translation mode, the controller circuit 220 of the wireless terminal 100 can initiate (block 402) establishment of a voice communication link to the language translation server 140, such as by dialing (dataflow 404) a telephone number of the language translation server 140. The language translation server 140 can respond to establishment of the communication link by transmitting (dataflow 406) a command that indicates a preferred speech sampling rate, a preferred speech coding rate, and/or a preferred speech coding algorithm that it prefers for the wireless terminal 100 (e.g. the vocoder 224) to use when generating a speech signal that is transmitted to the language translation server 140. Accordingly, the language translation server 140 can communicate its speech coding preferences, such that when accommodated by the wireless terminal 100, may improve the accuracy of the speech recognition and/or the language translation that is carried out by the language translation server 140.

The controller circuit 220 in the wireless terminal 100 can respond to the command (dataflow 406) by selecting (block 408) a speech sampling rate and/or a speech coding rate, and/or by selecting (block 410) a speech coding algorithm among a plurality of speech coding algorithms, and which is used, such as by the vocoder 224, to generate the speech signal for transmission to the language translation server 140.

The controller circuit 220 can generate metadata (block 412), such as was described above with regard to block 310 of FIG. 3, and which may additionally or alternatively identify what sampling rate, coding rate, and/or speech coding algorithm it will use to generate the speech signal that will be transmitted to the language translation server 140. The controller circuit 220 transmits (dataflow 414) the metadata to the language translation server 140.

The language translation server 140 can determine (block 416), as described above for block 314 of FIG. 3, from the metadata which one of a plurality of known spoken languages is contained in the speech of the recorded voice file and/or to identify what target language among a plurality of spoken languages a user desires for the speech to be translated into and, which, thereby may improve the accuracy of the speech recognition and/or translation by the language translation server 140.

Speech sensed by the microphone 222 is encoded by the vocoder 224, using the selected coding rate/algorithm to generate (block 418) a speech signal that is transmitted (dataflow 420) through the established voice communication link to the language translation server 140. The language translation server 140 carries out speech recognition (block 422), generates a speech recognition playback signal (block 424), transmits (dataflow 426) the speech recognition signal 426 to the wireless terminal 100 for playback thereon as described above with regard to blocks 316 and 318 and dataflow 320 in FIG. 3.

The wireless terminal 100 may play (block 428) the speech recognition signal through the speaker(s) 226/228 to enable the user thereof to verify and confirm accuracy of the speech recognized by the language translation server 140. The wireless terminal 100 may, for example, periodically interrupt the user with the playback of the recognized speech and/or may wait for the user to pause for a least a threshold time before playing back at least a portion of the recognized speech. The controller circuit 220 can query the user regarding acceptability of accuracy of the recognize speech, and can transmit (dataflow 430) the user's response to the language translation server 140.

The language translation unit 246 generates translated speech (block 432) into the selected target spoken language, which is different from the original spoken language, in response to the predefined data generated by the speech recognition unit 244. The language translation unit 246 transmits (dataflow 434) the translated speech, such as within a translated speech file through the network interface 240 and the wireline and wireless infrastructure to the wireless terminal 100. The language translation unit 246 may selectively generate/not generate the translated speech or may selectively transmits/not transmit the translated speech in response to whether the user indicated that the accuracy of the recognize speech is acceptable.

The controller circuit 220 of the wireless terminal 100 plays (block 436) the translated speech through the speaker(s) 226/228. When the translated speech is encoded by the vocoder 242 of the language translation server 140, it may be decoded by the vocoder 224 before being audibly broadcast from the wireless terminal 100.

Accordingly, a user can speak a first language into the wireless terminal 100 and through a voice communication link to the language translation server 140, and have the spoken words electronically translated by the language translation server 140 into a different target language which is audibly broadcast from the wireless terminal 100 for listening by another person.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A wireless communication terminal comprising:
a speaker;
a wireless transceiver; and
a controller circuit that is configured to selectively differently in a language translation mode than when operating in a non-language translation mode, wherein when operating in the language translation mode the controller circuit transmits a speech signal containing speech in a first spoken language via the transceiver to a language translation server, it receives from the language translation server a translated speech signal in a second spoken language which is different from the first spoken language, and it plays the translated speech signal through the speaker.

2. The wireless communication terminal of claim 1, wherein when operating in the language translation mode, the controller circuit is configured to record the speech signal into a voice file, to transmit the voice file to the language translation server, to receive a translated language speech file containing the translated speech signal in the second spoken language, and to play the translated speech signal through the speaker.

3. The wireless communication terminal of claim 1, wherein when operating in the language translation mode, the controller circuit is configured to generate metadata that indicates presence of the first spoken language and/or the second spoken language out of a plurality of possible spoken languages, and to transmit the metadata to the language translation server for use in translating speech in the speech signal from the first spoken language to the second spoken language.

4. The wireless communication terminal of claim 3, wherein the controller circuit identifies a language of speech in response to what language setting has been selected by a user for display of one or more textual menus on the wireless terminal, and generates the metadata in response to the identified language.

5. The wireless communication terminal of claim 3, wherein the metadata generated by the controller circuit identifies a present geographic location of the wireless terminal.

6. The wireless communication terminal of claim 3, wherein the controller circuit queries a user to identify at least one of the first and second languages, and the metadata generated by the controller circuit identifies the user response to the query.

7. The wireless communication terminal of claim 1, wherein when operating in the language translation mode the controller circuit selects a sampling rate, a coding rate, and/or a speech coding algorithm that is different than that selected when operating in the non-language translation mode and which is used to regulate conversion of speech in the first spoken language into the speech signal that is transmitted to the language translation server.

8. The wireless communication terminal of claim 7, wherein when operating in the language translation mode the controller circuit selects a higher sampling rate, a higher coding rate, and/or a speech coding algorithm providing better quality speech coding in the speech signal than that selected when operating in the non-language translation mode.

9. The wireless communication terminal of claim 7, wherein when operating in the language translation mode the controller circuit receives a command from the language translation server that identifies a sampling rate, a coding rate, and/or a speech coding algorithm that is preferred for use when generating the speech signal for transmission to the language translation server, and the controller circuit responds to the command by selecting the sampling rate, the coding rate, and/or the speech coding algorithm that it uses to generate the speech signal for transmission to the language translation server.

10. The wireless communication terminal of claim 7, wherein when operating in the language translation mode the controller circuit generates metadata that is indicative of the selected sampling rate, coding rate, and/or speech coding algorithm, and transmits the metadata to the language translation server for use in translating speech in the speech signal from the first spoken language to the second spoken language.

11. The wireless communication terminal of claim 1, wherein when operating in the language translation mode the controller circuit is configured to receive a speech recognition playback signal from the language translation server that contains speech generated by the language translation server as corresponding to what it recognized in the speech signal, configured to play the speech recognition playback signal through the speaker, to query a user regarding acceptability of accuracy of speech in the speech recognition playback signal, and to transmit the user response to the query to the language translation server.

12. A language translation server comprising:
a network interface that communicates with wireless terminals via a wireless communication system;
a speech recognition unit is configured to receive a speech signal in a first spoken language from the wireless terminals, and maps the received speech signal to predefined data; and
a language translation unit that is configured to generate translated speech in a second spoken language, which is different from the first spoken language, in response to the predefined data, and to transmit the translated speech to the wireless terminals.

13. The language translation server of claim 12, wherein the language translation unit receives metadata that indicates a geographic location of one of the wireless terminals, and selects the second spoken language among a plurality of spoken languages and into which it generates the translated speech for the wireless terminal in response to the indicated geographic location.

14. The language translation server of claim 13, wherein the language translation unit receives metadata that identifies geographical coordinates of the wireless terminal and/or indicates a geographic location of network infrastructure that is communicating with and is proximately located to the wireless terminal, and selects the second spoken language among a plurality of spoken languages and into which it generates the translated speech for the wireless terminal in response to the metadata.

15. The language translation server of claim 12, wherein the speech recognition unit receives metadata from one of the wireless terminals that identifies a language setting that has been selected by a user for display of one or more textual menus on the wireless terminal, and uses the metadata to identify the first spoken language among a plurality of spoken languages and to recognize speech in a speech signal received from the wireless terminal.

16. The language translation server of claim 12, wherein the speech recognition unit receives metadata that identifies a home geographic location of one of the wireless terminals, and uses the identified home geographic location to identify the first spoken language among a plurality of spoken languages and to recognize speech in a speech signal received from the wireless terminal.

17. The language translation server of claim 12, wherein the speech recognition unit transmits a command to one of the wireless terminals that identifies a sampling rate, a coding rate, and/or a speech coding algorithm that is preferred for use when generating the speech signal for transmission to the language translation server.

18. The language translation server of claim 12, wherein the speech recognition unit receives metadata from one of the wireless terminals that identifies a sampling rate, a coding rate, and/or a speech coding algorithm that will be used by the wireless terminal when generating the speech signal for transmission to the language translation server.

19. The language translation server of claim 12, wherein:
the speech recognition unit generates a speech recognition playback signal that contains speech generated by the speech recognition unit as corresponding to what it recognized in the speech signal from one of the wireless terminals, transmits the speech recognition playback signal to the wireless terminal, and receives a user response from the wireless terminal regarding acceptability of accuracy of speech in the speech recognition playback signal; and
the language translation unit selectively transmits translated speech in the second language to the wireless terminal in response to the user response.

20. A method of electronically translating speech between different languages, the method comprising:
carrying out by a wireless terminal, recording a speech signal of a first spoken language into a voice file and transmitting the voice file to a language translation server;
carrying out by the language translation server, receiving the voice file, generating a file of translated speech in a second spoken language, which is different from the first spoken language, in response to speech in the voice file and transmitting the file of translated speech in the second spoken language to the wireless terminal; and
carrying out by the wireless terminal, receiving the file of translated speech and playing the speech in the second spoken language through a speaker.
